(19) United States
(12) Patent Application Publication
(10) Pub. No.: US 2009/0279324 A1
(43) Pub. Date: Nov. 12, 2009

(54) LIGHT GUIDE PLATE STRUCTURE

(76) Inventors: Ping-Yeng CHEN, Tai Chung County (TW); Kuo-Jui Huang, Tai Chung county (TW); Tzu Ting Hung, Tai Chung City (TW)

Correspondence Address: Muncy, Geissler, Olds & Lowe, PLLC, P.O. BOX 1364, FAIRFAX, VA, 22038-1364, US

(21) Appl. No.: 12/437,788

(22) Filed: May 8, 2009

(30) Foreign Application Priority Data
May 9, 2008 (TW) 097117102

(51) Int. Cl. F21V 7/22; F21S 8/10

(52) U.S. Cl. 362/616; 362/317

(57) ABSTRACT

The invention discloses a light guide plate structure. The light guide plate structure includes a light-receiving surface, a light-emitting surface and a light-reflecting surface. The light-receiving surface receives emitting light from at least a light source, and the light propagating in the light guide plate exits through the light-emitting surface. The light-reflecting surface is opposite to the light-emitting surface for guiding the light that passes through the light-receiving surface to the light-emitting surface. The light-emitting surface and/or the light-reflecting surface include at least a composite structure. The composite structure includes a primary structure and a secondary structure where the secondary structure is disposed to a side of the primary structure.

### BACKGROUND OF THE INVENTION

(a) Field of the Invention

The present invention relates to a light guide plate structure, and more particularly, to a light guide plate structure having excellent light guiding efficiency.

(b) Description of the Related Art

Currently, most of the light guide plates are processed by etching method and the shape of its surface structure can have a variety of geometrical shapes, such as: circle, rectangle, diamond shape, or the like.

Generally, when producing a light guide plate G as shown in FIG. 1A, an indent structure Tc is usually etched into the stamper T. Then, the light guide plate G is formed on the stamper T by the injection molding method.

However, During the injection molding process, it is common that the surface structure Gc of the light guide plate is poorly formed due to air enclosure between the indenting structure Tc and the injected material. Thus, the geometrical shapes having larger indenting depth (such as cone shape or sphere) shown in FIG. 1A cannot be achieved. Hence, when light enters the light guide plate G with poorly formed surface structure Gc from the left-hand side as shown in FIG. 1B, the light diffusing efficiency becomes low due to the poorly formed surface structure Gc.

### BRIEF SUMMARY OF THE INVENTION

In light of the above-mentioned problem, one object of the invention is to provide a light guide plate structure to have the light radiated from light source(s) more evenly so as to increase the light guiding efficiency.

One embodiment of the invention provides a light guide plate. The light guide plate includes a light-receiving surface, a light-emitting surface, and a light-reflecting surface. The light-receiving surface is for receiving light from at least one light source. The light-emitting surface is for the light that enters the light guide plate to exit through the light-emitting surface. The light-reflecting surface is opposite to the light-emitting surface for reflecting the light that enters the light guide plate via the light-receiving surface to the light-emitting surface. The light-emitting surface or the light-reflecting surface, or both include at least one composite structure. The composite structure includes at least a primary structure and at least a secondary structure, and the secondary structure is disposed to a side of the primary structure. The primary structure and the secondary structure are formed toward the opposite direction with reference to a plane of the light-emitting surface or a plane of the light-reflecting surface, respectively.

Another embodiment of the invention provides a light guide plate. The light guide plate is for receiving and guiding the light generated from at least one light source to exit therethrough. The light guide plate includes a plurality of surfaces wherein at least a first surface includes a plurality of composite structures. The composite structure includes at least a primary structure and at least a secondary structure and the secondary structure is placed around the primary structure. The primary structure and the secondary structure are formed toward the opposite direction with reference to a plane of the first surface.

Another embodiment of the invention provides a backlight module. The backlight module includes at least one light source and at least one light guide plate. The light guide plate includes a light-receiving surface, a light-emitting surface, and a light-reflecting surface. The light-receiving surface is adjacent to the light source for receiving the light from the light source. The light-emitting surface is for the light that enters the light guide plate to exit the light guide plate. The light-reflecting surface is opposite to the light-emitting surface for reflecting the light that enters the light guide plate via the light-receiving surface to the light-emitting surface. The light-emitting surface or the light-reflecting surface, or both include a plurality of composite structures. Each of the composite structures includes at least a primary structure and at least a secondary structure, and the secondary structure is disposed around the primary structure. The primary structure and the secondary structure are formed toward the opposite direction with reference to a plane of the light-emitting surface or a plane of the light-reflecting surface, respectively.

The backlight module and the light guide plate thereof according to the embodiments of the invention utilize the combination of the protruding and the indenting curved surfaces of the composite structures to increase the overall surface roughness of the light-emitting surface and/or the light-reflecting surface for solving the problem of uneven light diffusion that may occur when the light enters the light guide plate. Increasing the light diffusing efficiency can be achieved.

### BRIEF DESCRIPTION OF THE DRAWINGS

FIG. 1A shows a schematic diagram illustrating a light guide plate according to the prior art;

FIG. 1B shows a schematic diagram illustrating the light propagation of the light guide plate according to the prior art;

FIG. 2 shows a schematic diagram illustrating the backlight module according to one embodiment of the invention;

FIG. 3A shows a schematic diagram illustrating the top perspective view of the light guide plate according to one embodiment of the invention;

FIG. 3B shows a schematic diagram illustrating the enlarged drawing of the composite structure according to one embodiment of the invention;

FIG. 4 shows a schematic diagram illustrating the light propagation of the light guide plate according to one embodiment of the invention;

FIG. 5 shows a schematic diagram illustrating the backlight module according to one embodiment of the invention;

FIG. 6 shows a schematic diagram illustrating the light propagation of the light guide plate according to one embodiment of the invention; and

FIGS. 7A-9B show schematic diagrams illustrating the composite structures according to one embodiment of the invention.

### DETAILED DESCRIPTION OF THE INVENTION

The following descriptions together with the relevant drawings illustrate the embodiments of the invention in detail so that those who are skilled in the art can implement the invention. It should be noted that, although there are differences in the embodiments of the invention, the structures or the features related to any embodiments of the invention as described in the disclosure can be applied in other embodiments of the invention without deviating from the scope of the invention and should not be construed as any limitation on the implementation of the invention. Besides, it should be recognized that the arrangement and the position of each individual part in the embodiments of the invention, that are explicitly described, can be altered as long as the arrangement and the position are within the scope of the invention. That is, the scope of the present invention is defined by the accompanying claims.

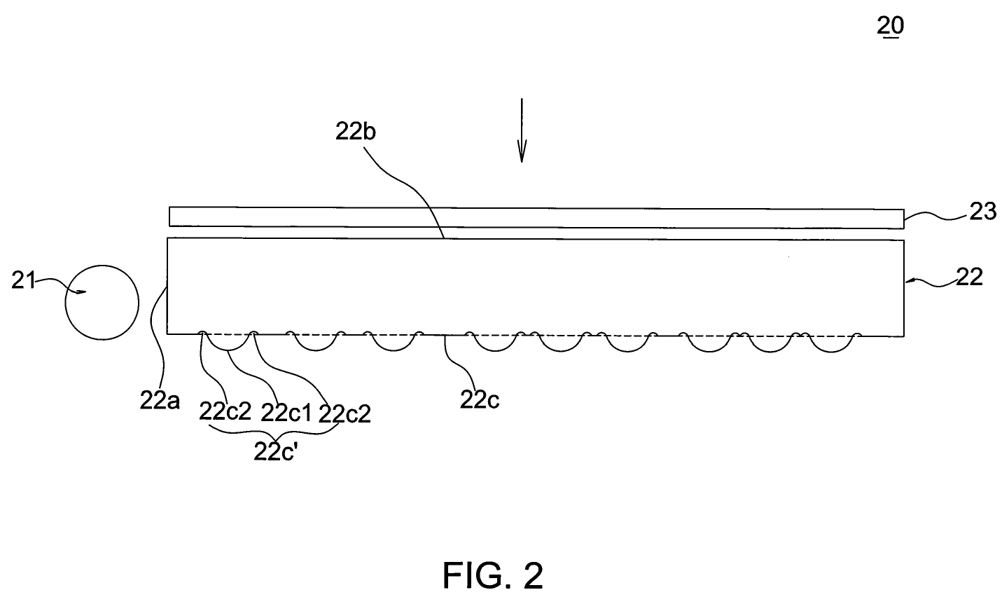

FIG. 2 shows a schematic diagram illustrating the backlight module according to one embodiment of the invention. The backlight module 20 includes a light source 21, a light guide plate 22, and a light conducting element 23.

The light source 21 can be a point light source, such as light emitting diodes (LED), various other existing light sources, or various light sources to be developed in the future.

The light guide plate 22 is for receiving and guiding the light generated from at least one light source 21 (such as a point light source) to exit the light guide plate. The light guide plate 22 further includes a light-receiving surface 22a, a light-emitting surface 22b, and a light-reflecting surface 22c. The light-receiving surface 22a is adjacent to the light source 21 for receiving the light from the light source 21. The light-emitting surface 22b and the light-receiving surface 22a form an included angle. The light-emitting surface 22b is for the light that enters the light guide plate 22 via the light-receiving surface 22a to exit the light guide plate 22. The light-reflecting surface 22c opposite to the light-emitting surface 22b is for reflecting the light that enters the light guide plate 22 via the light-receiving surface 22a to the light-emitting surface 22b. The light-reflecting surface 22c includes at least one composite structure 22c′ (a plurality of composite structures are shown in the figure). Each of the composite structures includes at least a primary structure 22c1 and at least a secondary structure 22c2, and the secondary structure 22c2 is disposed to (or around) the side, the edge, or the periphery of the primary structure 22c1. The primary structure 22c1 and the secondary structure 22c2 can be formed toward the opposite direction with reference to a plane of the light-emitting surface 22b or a plane of the light-reflecting surface 22c, respectively. According to one embodiment of the invention, the primary structure 22c1 of the composite structure 22c′ of the light guide plate 22 can be of half-cone shape or hemisphere shape protruding a plane of the light-reflecting surface 22c. For example, the secondary structure 22c2 can be an “O” shaped groove indenting a plane of the light-reflecting surface 22c.

The light conducting element 23 can be a prism sheet, a diffusing sheet, or any combination thereof, disposed between the light guide plate 22 and a display panel (not shown in the figure).

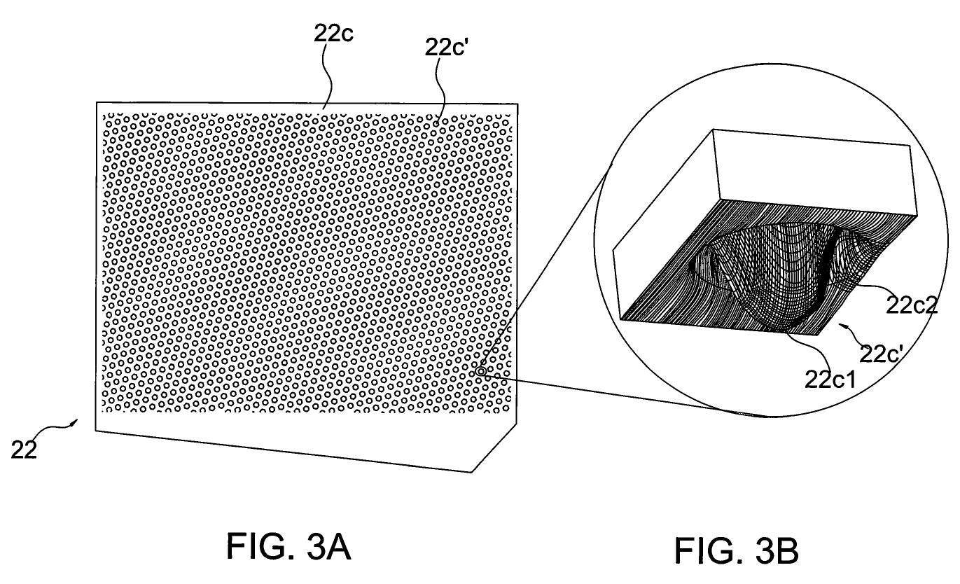

FIG. 3A shows a schematic diagram illustrating the top perspective view of the light guide plate 22 along the direction of the arrow shown in FIG. 2. As the figure illustrates the light guide plate 22 via the perspective drawing, a plurality of composite structures 22c′ arranged in a pre-determined pattern on the light-reflecting surface 22c can be observed. It should be noted that the arrangement of the composite structures 22c′ is only shown as an example. The pattern and the density of the arrangement can be design by the user at will. FIG. 3B shows a schematic diagram illustrating the simulated enlarged drawing of the composite structure 22c′. The embodiments of the primary structure 22c1 and the secondary structure 22c2 according to the invention can be seen in the figure. According to one embodiment of the invention, the secondary structure 22c2 is disposed to a side of the primary structure 22c1 in a continuous surrounding fashion and the primary structure 22c1 and the secondary structure 22c2 mutually contact with each other. In another embodiment of the invention, the disposition of the primary/secondary structures 22c1, 22c2 can contact with each other by remaining a gap between them or partially contacting with each other. The secondary structure 22c2 according one other embodiment of the invention can also be disposed to a side of the primary structure in an intermittently surrounding fashion.

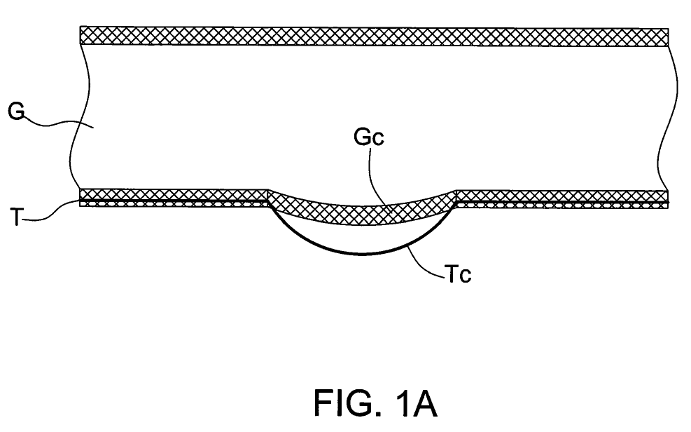

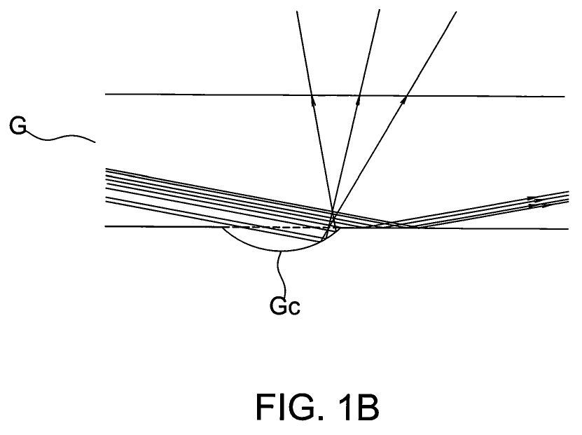

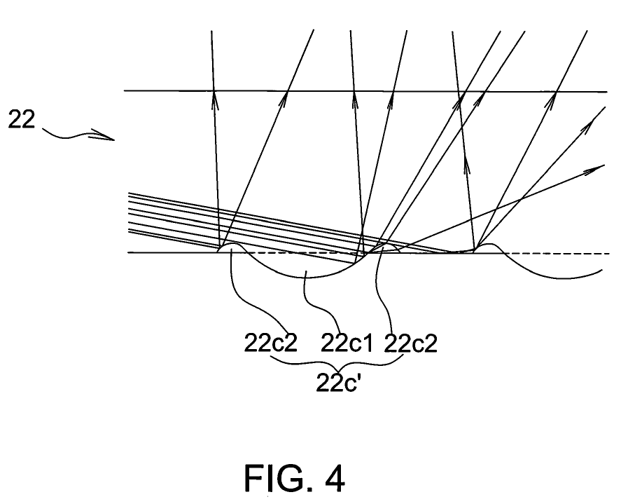

Referring to the FIGS. 1A, 1B, and 4 at the same time, the following describe the backlight module and the light guide plate thereof according to the embodiments of the invention to solve the problems in the prior art and to increase light diffusing efficiency.

FIG. 4 shows a schematic diagram illustrating the light trace of the light guide plate according to one embodiment of the invention. When the light from the light source 21 enters the light guide plate 22 from the left-hand side of the figure, one portion of the light is diffused upwardly out of the light guide plate 22 via the secondary structure 22c2 while the remaining portion of the light is diffused upwardly out of the light guide plate 22 via the primary structure 22c1. The primary/secondary structures functioning together can increase the light diffusing effect. Such diffusing efficiency is far higher than the light diffusing efficiency in the prior art shown in FIG. 1B (only a portion of the light received shown in FIG. 1B is diffused upwardly out of the light guide plate G via the surface structure Gc while the remaining portion is scattered toward the right-hand side of the figure and is not diffused out of the light guide plate G). As can be seen, the light guide plate 22 according to the embodiment of the invention utilizes the secondary structure 22c2 disposed to a side of the original primary structure 22c1, protruding or indented correspondingly, to increase the overall surface roughness of the light-reflecting surface 22c of the light guide plate 22. The light diffusing efficiency can be increased by reflecting the light simultaneously via the primary/secondary structures 22c1, 22c2 to achieve the better light diffusing effect than that of the prior art. Certainly, if the above mentioned injection molding problem in the prior art as shown in FIG. 1A causes the depth of the primary structure 22c1 to become shallow, the secondary structure 22c2 according to the embodiment of the invention not only compensates the light diffusion loss caused by the poorly formed primary structure 22c1 but also solves the technical problems in the prior art.

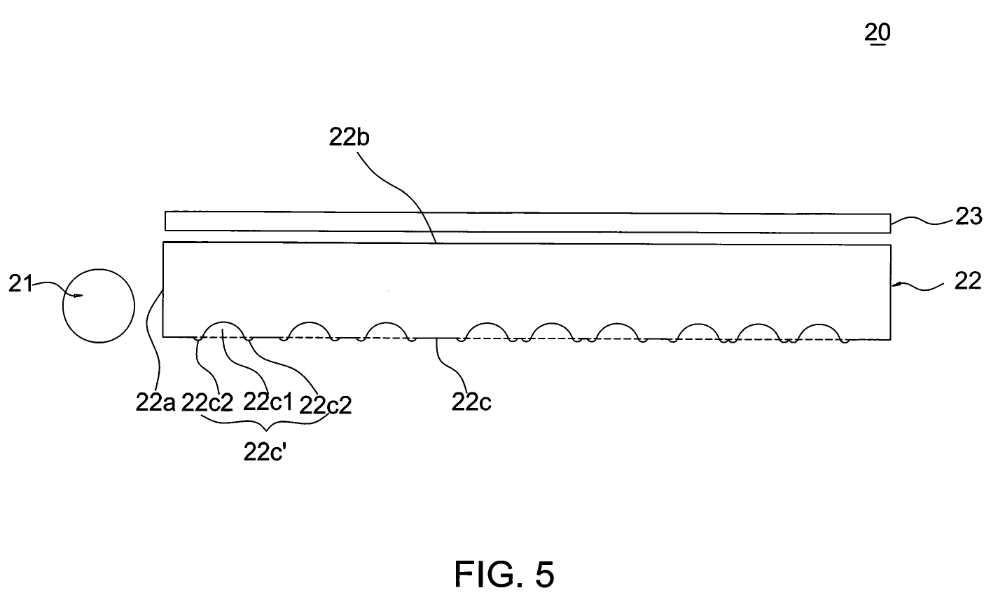

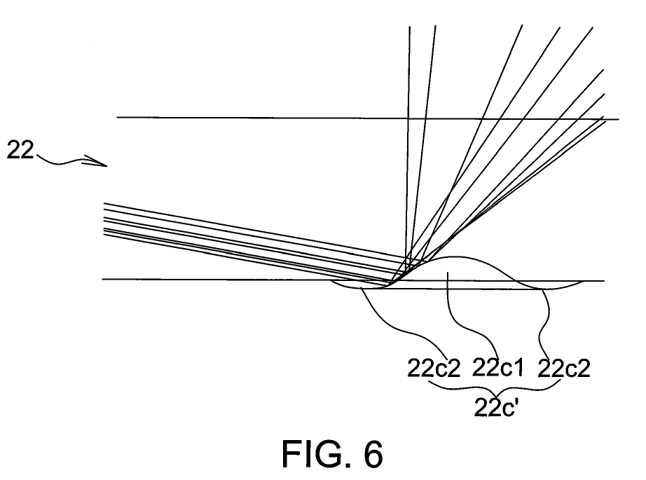

FIG. 5 shows a schematic diagram illustrating the backlight module according to another embodiment of the invention. The architecture of the backlight module of this embodiment is similar to that of the backlight module shown in FIG. 2. The details of its structure will not be described. However, the technical differences will be given in the following descriptions. The primary structure 22c1 of the composite structure 22c′ according to this embodiment shown in FIG. 5 is a half-cone or a hemisphere indenting into a plane of the light-reflecting surface 22c. In addition, the secondary structure 22c2, for example, is an O shaped bump disposed around the primary structure 22c1 and protruding a plane of the light-reflecting surface 22c. FIG. 6 shows a schematic diagram illustrating the light propagation of the light guide plate according to this embodiment. As shown in the figure, the light diffusing efficiency better than that in the prior art can be achieved by the primary/secondary structures 22c1, 22c2 functioning together.

Besides, the composite structure of the light guide plate according to the invention can be formed by alternately disposing a plurality of primary structures and a plurality of secondary structures. The primary structure and the secondary structure can also be alternately disposed to be indenting or protruding structures. Certainly, the composite structure can also be formed by alternately disposing one primary structure and a plurality of secondary structures. Hence, the variety and the complexity of the structure of the light-reflecting surface 22c can be increased to further increase the light diffusing efficiency.

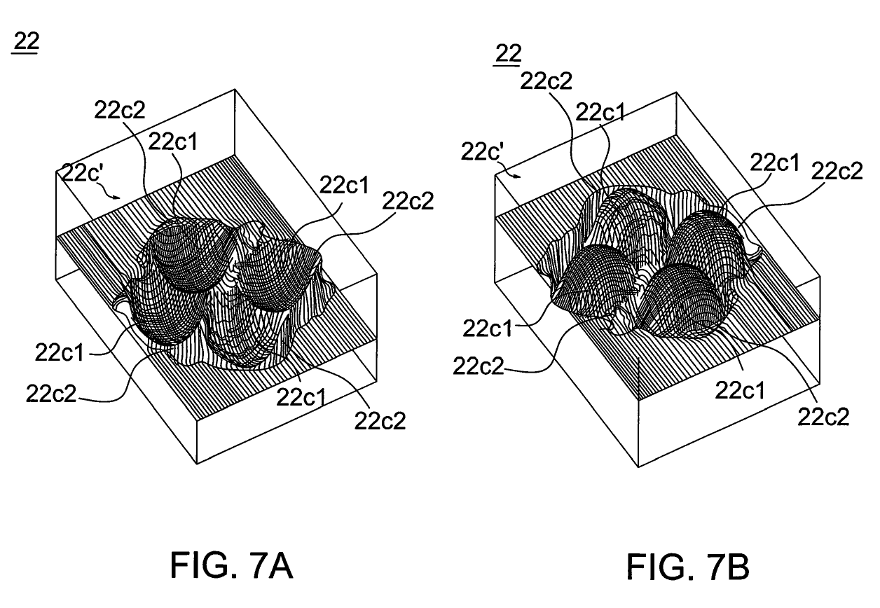

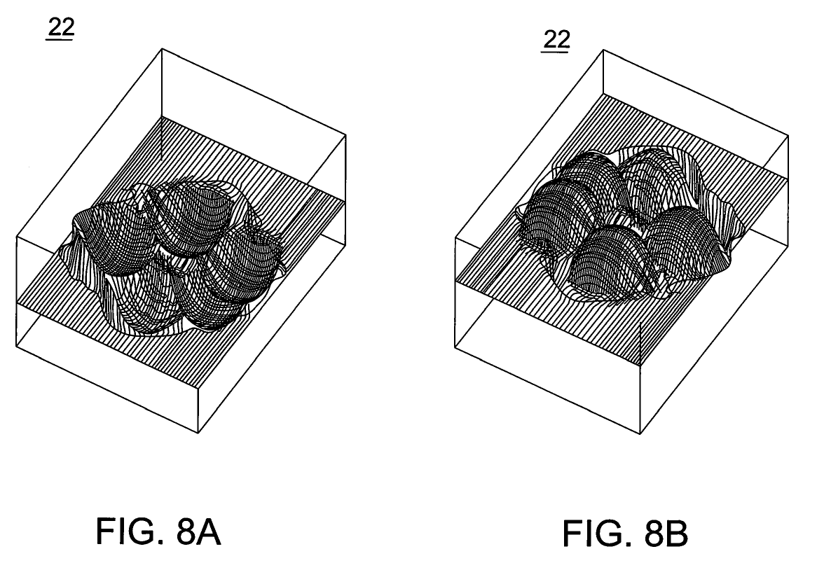

The light guide plate according to another embodiment of the invention is shown in FIG. 7A. The composite structure 22c′ of the light guide plate 22 according to this embodiment is formed by the union of four primary structures 22c1 indenting into a plane of the light guide plate 22 and four secondary structures 22c2 protruding a plane of the light guide plate 22. The light guide plate according to one other embodiment of the invention is shown in FIG. 7B. The composite structure 22c′ of the light guide plate 22 according to this embodiment is formed by the union of four primary structures 22c1 protruding a plane of the light guide plate 22 and four secondary structures 22c2 indenting into a plane of the light guide plate 22. FIGS. 8A, 8B show the composite structures of the light guide plate according to one other embodiment of the invention. In these two figures, the indenting or protruding structures of the primary structure and the secondary structure are disposed in reverse.

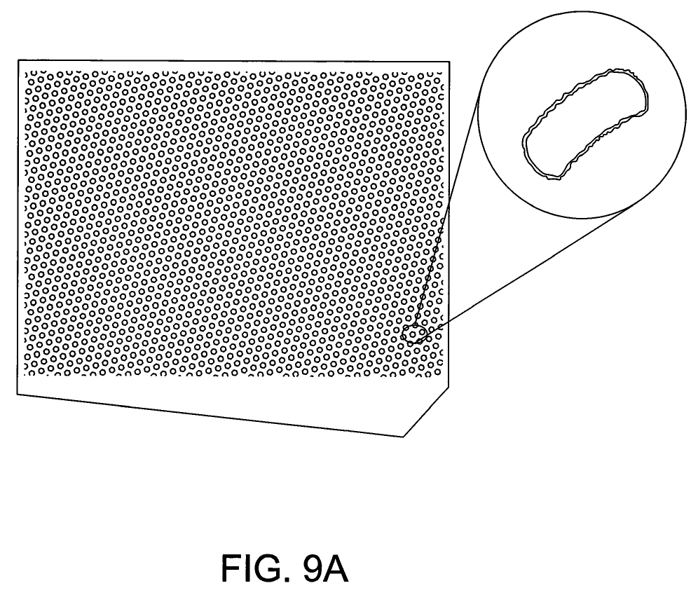

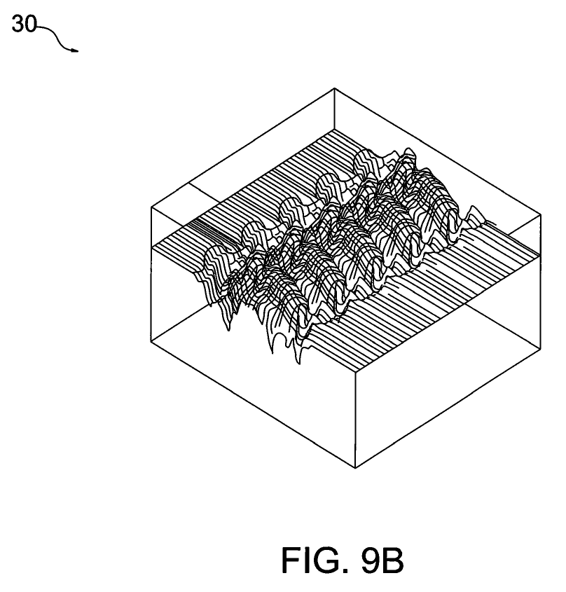

The primary structure 22c1 and the secondary structure 22c2 can be belt-like (or stripe-like) structures according to one embodiment of the invention shown in FIG. 9A. The solid drawing of the simulated structures is shown in FIG. 9B.

It should be noted that, according to the embodiments of the invention, the size and the height of the primary structure of the composite structure to those of the secondary structure of the composite structure are of a pre-determined ratio. For example, the height ratio of the primary structure to that of the secondary structure can be 5:1 or 5:2. For instance, when the height of the primary structure is 30 μm, the height of the secondary structure is designed to be 6˜12 μm. Or, the diameter of the primary structure can be 20˜160 μm while the diameter of the secondary structure is 10˜40 ˜m. Certainly, the data shown in the above mentioned pre-determined values are only examples used to describe the embodiments of the invention and should not be construed as any limitation on the scope of implementing the invention. Besides, the numbers of the primary/secondary structures are also not limited to the above-mentioned examples. The primary or the secondary structures can be of various forms. For example, the surface of the primary structure and/or the secondary structure is selected from the group consisting of the following: a curved surface, a rough surface, a smooth surface, or any combination thereof. Please note that the primary structure and the secondary structure can be disposed on the light-emitting surface or the light-reflecting surface of the light guide plate, or disposed on both of the light-emitting surface and the light-reflecting surface, simultaneously. The shapes of the primary/secondary structures can be a stripe-like shape, an O-shaped groove, an O-shaped bump, a cone, half cone, a hemisphere, a diamond shape, a rectangular shape, an irregular structure, or the like, or any combination thereof.

In conclusion, the backlight module and the light guide plate thereof according to the embodiments of the invention utilize the combination of the protruding and the indenting curved surfaces of the composite structures to increase the overall surface roughness of the light-emitting surface and/or the light-reflecting surface for solving the problem of uneven light diffusion that may occur when the light enters the light guide plate. According to the present invention, increasing light diffusing efficiency can be achieved.

What is claimed is:

1. A light guide plate, comprising:
a light-receiving surface for receiving light from at least one light source;
a light-emitting surface guiding the light that enters the light guide plate to exit the light guide plate; and
a light-reflecting surface being opposite to the light-emitting surface for reflecting the light that enters the light guide plate via the light-receiving surface to the light-emitting surface;
wherein at least one of the light-emitting surface and the light-reflecting surface comprises a plurality of composite structures, each of the composite structures includes at least a primary structure and at least a secondary structure, and the secondary structure is disposed to a side of the primary structure where the primary structure and the secondary structure are formed toward the opposite direction with reference to a plane of the light-emitting surface or a plane of the light-reflecting surface, respectively.

2. The light guide plate according to claim 1, wherein the primary structure protrudes out the plane of the light-emitting surface and the secondary structure dents into the plane of the light-emitting surface when the composite structures are formed on the light-emitting surface.

3. The light guide plate according to claim 1, wherein the primary structure protrudes out the plane of the light-reflecting surface and the secondary structure dents into the plane of the light-reflecting surface when the composite structures are formed on the light-reflecting surface.

4. The light guide plate according to claim 1, wherein the primary structure dents into the plane of the light-emitting surface and the secondary structure protrudes out the plane of the light-emitting surface when the composite structures are formed on the light-emitting surface.

5. The light guide plate according to claim 1, wherein the primary structure dents into the plane of the light-reflecting surface and the secondary structure protrudes out the plane of the light-reflecting surface when the composite structures are formed on the light-reflecting surface.

6. The light guide plate according to claim 1, wherein the shape of the primary structure is a half cone or hemisphere.

7. The light guide plate according to claim 1, wherein the surface of the primary structure and the secondary structure is selected from the group consisting of the following: a curved surface, a rough surface, a smooth surface, or any combination thereof.

8. The light guide plate according to claim 1, wherein the composite structure is formed by a plurality of primary structures and a plurality of secondary structures that surround the primary structures.

9. The light guide plate according to claim 1, wherein the secondary structure surrounds the primary structure.

10. A light guide plate for receiving and guiding the light generated from at least one light source to exit therethrough, the light guide plate comprising:
a plurality of surfaces wherein at least a first surface comprises a plurality of composite structures including at least a primary structure and at least a secondary structure where the secondary structure is disposed around the primary structure, and the primary structure and the secondary structure are formed toward the opposite direction with reference to a plane of the first surface.

11. The light guide plate according to claim 10, wherein the plurality of composite structures are arranged in a pre-determined pattern on the first surface.

12. The light guide plate according to claim 10, wherein the primary structure protrudes out the plane relative to the first surface and the secondary structure dents into the plane relative to the first surface.

13. The light guide plate according to claim 10, wherein the primary structure dents into the plane relative to the first surface and the secondary structure protrudes out the plane relative to the first surface.

14. The light guide plate according to claim 10, wherein the surface of the primary structure and the secondary structure is selected from the group consisting of the following: a curved surface, a rough surface, a smooth surface, or any combination thereof.

15. The light guide plate according to claim 10, wherein the composite structure is one selected from the group consisting of the following: stripe-like structure, circular structure, rectangular structure, irregular structure, or any combination thereof.

16. The light guide plate according to claim 10, wherein the height ratio of the primary structure to that of the secondary structure is between 5:1 and 5:2, the diameter of the primary structure is between 20˜160 μm, and the diameter of the secondary structure is between 10˜40 μm.

17. A backlight module, comprising:
at least one light source; and
at least one light guide plate that comprises:
a light-receiving surface that is adjacent to the light source for receiving the light from the light source;
a light-emitting surface for the light that enters the light guide plate to exit through the light-emitting surface; and
a light-reflecting surface being opposite to the light-emitting surface for reflecting the light that enters the light guide plate via the light-receiving surface to the light-emitting surface;
wherein the light-emitting surface and/or the light-reflecting surface, or both comprise a plurality of composite structures, each of the composite structures includes at least a primary structure and at least a secondary structure, and the secondary structure is disposed around the primary structure where the primary structure and the secondary structure are formed toward the opposite direction with reference to a plane of the light-emitting surface or a plane of the light-reflecting surface, respectively.

18. The backlight module according to claim 17, further comprising: one selected from the group consisting of the following: a prism sheet, a diffusing sheet, or any combination thereof, disposed between the light guide plate and a display panel.

19. The backlight module according to claim 17, wherein the primary structure protrudes out the plane of the light-emitting surface or the plane of the light-reflecting surface and the secondary structure dents into the plane of the light-emitting surface or the plane of the light-reflecting surface.

20. The backlight module according to claim 17, wherein the primary structure dents into the plane of the light-emitting surface or the plane of the light-reflecting surface and the secondary structure protrudes out the plane of the light-emitting surface or the plane of the light-reflecting surface.
